(19) United States
(12) Patent Application Publication
(10) Pub. No.: US 2017/0024417 A1
(43) Pub. Date: Jan. 26, 2017

(54) INFORMATION PROCESSING SYSTEM AND INFORMATION PROCESSING METHOD THEREOF

(71) Applicants: Myeong Hwan LEE, Gyeonggi-do (KR); Tae Min SONG, Gyeonggi-do (KR)

(72) Inventors: Myeong Hwan LEE, Gyeonggi-do (KR); Tae Min SONG, Gyeonggi-do (KR)

(21) Appl. No.: 15/124,506

(22) PCT Filed: Mar. 11, 2015
(86) PCT No.: PCT/KR2015/002333

§ 371 Date: Sep. 8, 2016

(30) Foreign Application Priority Data
Mar. 11, 2014 (KR) 10-2014-0028573

(51) Int. Cl. G06F 17/30; G06K 9/00; G06K 9/68; G06F 3/0354

(52) U.S. Cl. CPC G06F 17/30268; G06F 3/03545; G06K 9/00429; G06K 9/6828

(57) ABSTRACT

An information processing system for a handwriting search according to an embodiment of the present invention comprises: an information extraction device for transforming pattern information sensed by an electronic pen into handwriting data on a recording medium with a pattern formed thereon; and an information management device for transforming the handwriting data into digital data, storing the handwriting data and the digital data, searching for digital data including a keyword when a search request including the keyword is received from a user terminal, and transmitting, to the user terminal, the handwriting data corresponding to the searched digital data.

### TECHNICAL FIELD

The present disclosure relates to an information processing system for a handwriting search, and an information processing method thereof.

### BACKGROUND

An electronic pen is a new-concept pen in which analog and digital are combined. When letters are written on a paper using the electronic pen, written information is transmitted to a computer and may be managed in the form of an image file. A document written with a normal pen may also be managed in the form of an image file when scanned by a scanner (an electronic color separation apparatus). However, a document written with an electronic pen has advantages in that a scanning process is not required and that the document can be easily managed through a separate program.

Meanwhile, a technology of sharing an image file including handwriting written using an electronic pen with another person is in demand For example, a need for sharing an e-book created with handwriting with another person or sharing a celebrity's handwriting through a social network service (SNS) exists.

However, since only an image file corresponding to a keyword pre-stored by a creator is found when a user attempts to search for an image file including handwriting, there is a problem of low efficiency.

### DISCLOSURE

### Technical Problem

The present disclosure is directed to providing an information processing system for a handwriting search, and an information processing method thereof.

### Technical Solution

According to an embodiment of the present disclosure, an information processing system for a handwriting search includes an information extraction device that transforms pattern information detected by an electronic pen from a recording medium with a pattern formed thereon into handwriting data, and an information management device that transforms the handwriting data into digital data, stores the handwriting data and the digital data, searches for digital data including a keyword when a search request including the keyword is received from a user terminal, and transmits handwriting data corresponding to the found digital data to the user terminal.

The handwriting data may include handwriting recorded on the recording medium by the electronic pen, and the digital data may include a digital font transformed from the handwriting.

The digital font may include a keyword transformed from the handwriting.

The information management device may include a digital data conversion unit that transforms handwriting data received from the information extraction device into digital data, a storage unit that stores the handwriting data and the digital data, a search unit that searches for digital data including the keyword and extracts handwriting data corresponding to the digital data, and a communication unit that communicates with the user terminal, receives the keyword from the user terminal, and transmits the handwriting data to the user terminal.

The storage unit may further store an image together with the handwriting data.

The search unit may combine the handwriting data with the image, and the communication unit may transmit the handwriting data combined with the image to the user terminal.

According to an embodiment of the present disclosure, an information processing method for a handwriting search in an information processing system includes transforming pattern information detected by an electronic pen from a recording medium with a pattern formed thereon into handwriting data, transforming the handwriting data into digital data, storing the handwriting data and the digital data, searching for digital data including a keyword when a search request including the keyword is received from a user terminal, and transmitting handwriting data corresponding to the found digital data to the user terminal.

### Advantageous Effects

According to an embodiment of the present disclosure, an image file including handwriting can be easily found. Particularly, an amount of time taken for searching for an image file including handwriting and information throughput can be reduced. Accordingly, an e-book created with handwriting, a celebrity's handwriting, etc. can be actively shared with other people.

### DESCRIPTION OF DRAWINGS

FIG. 1 is a block diagram illustrating a search system according to an embodiment of the present disclosure.

FIG. 2 is an example of an electronic pen according to an embodiment of the present disclosure.

FIG. 3 is an example of an electronic pen and a recording medium according to an embodiment of the present disclosure.

FIGS. 4 and 5 are views for describing a dot pattern formed on a recording medium according to an embodiment of the present disclosure.

FIG. 6 is a block diagram of an information processing system according to an embodiment of the present disclosure.

FIG. 7 illustrates an example in which digital data, handwriting data, and a background image are stored in a storage unit of an information management device according to an embodiment of the present disclosure.

FIG. 8 is a block diagram of a user terminal according to an embodiment of the present disclosure.

FIG. 9 is a flowchart illustrating a handwriting search method of a search system according to an embodiment of the present disclosure.

### MODES OF THE INVENTION

Since various modifications may be made to the present disclosure and the present disclosure may have various embodiments, particular embodiments will be illustrated in the drawings and described. However, this does not limit the present disclosure to the particular embodiments, and all modifications, equivalents, and substitutes included in the spirit and scope of the present disclosure should be construed as belonging to the present disclosure.

Terms including ordinal numbers such as first and second may be used to describe various elements, but the elements are not limited by the terms. The terms are only used for the purpose of distinguishing one element from another element. For example, a second element may be referred to as a first element while not departing from the scope of the present disclosure, and likewise, a first element may also be referred to as a second element. The term and/or includes a combination of a plurality of related described items or any one item among the plurality of related described items.

When it is mentioned that a certain element is “connected” or “linked” to another element, although the certain element may be directly connected or linked to the other element, it should be understood that another element may exist therebetween. On the other hand, when it is mentioned that a certain element is “directly connected” or “directly linked” to another element, it should be understood that other elements do not exist therebetween.

Terms used in the application are merely used to describe particular embodiments and are not intended to limit the present disclosure. A singular expression includes a plural expression unless the context clearly indicates otherwise. In the application, terms such as “include” or “have” should be understood as designating that features, number, steps, operations, elements, parts, or combinations thereof exist and not as precluding the existence of or the possibility of adding one or more other features, numbers, steps, operations, elements, parts, or combinations thereof.

Unless otherwise defined, all terms including technical or scientific terms used herein have the same meaning as commonly understood by one of ordinary skill in the art to which the disclosure pertains. Terms, such as those defined in commonly used dictionaries, should be construed as having a meaning that is consistent with their meaning in the context of the relevant art and are not to be construed in an idealized or overly formal sense unless expressly so defined herein.

Hereinafter, an embodiment will be described in detail with reference to the accompanying drawings while like reference numerals will be given to the same or corresponding elements regardless of signs in the drawings and overlapping descriptions thereof will be omitted.

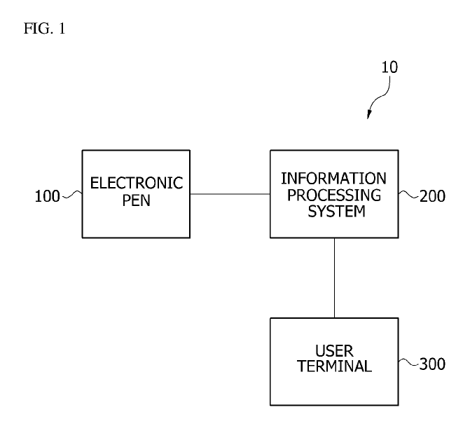

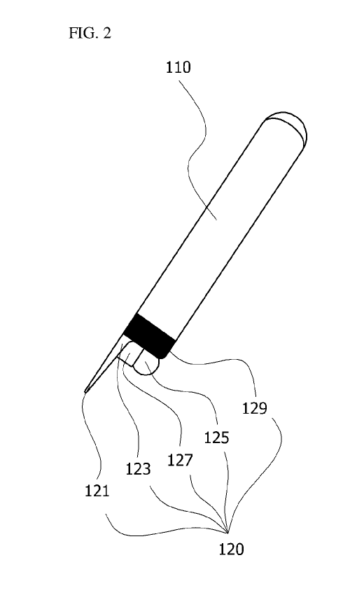

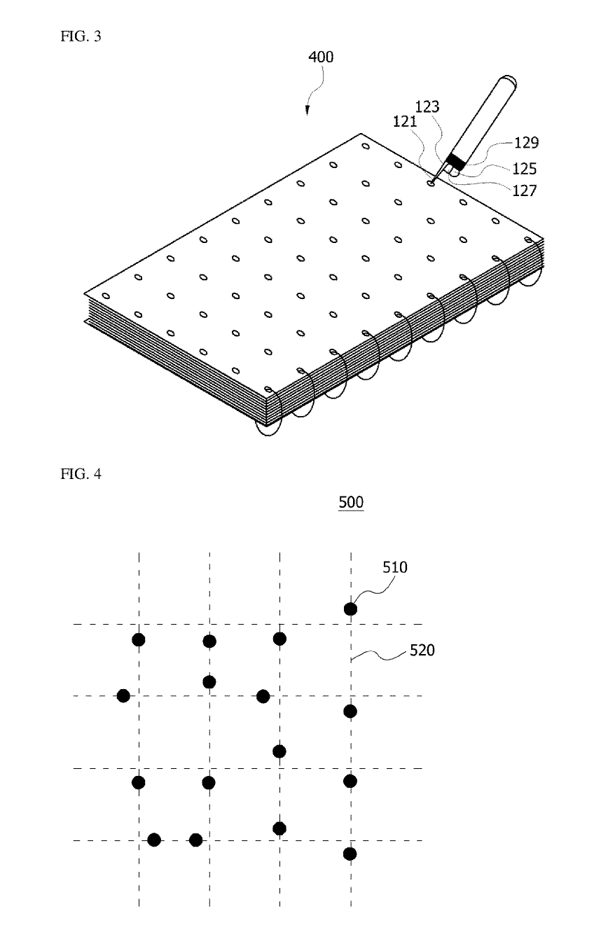

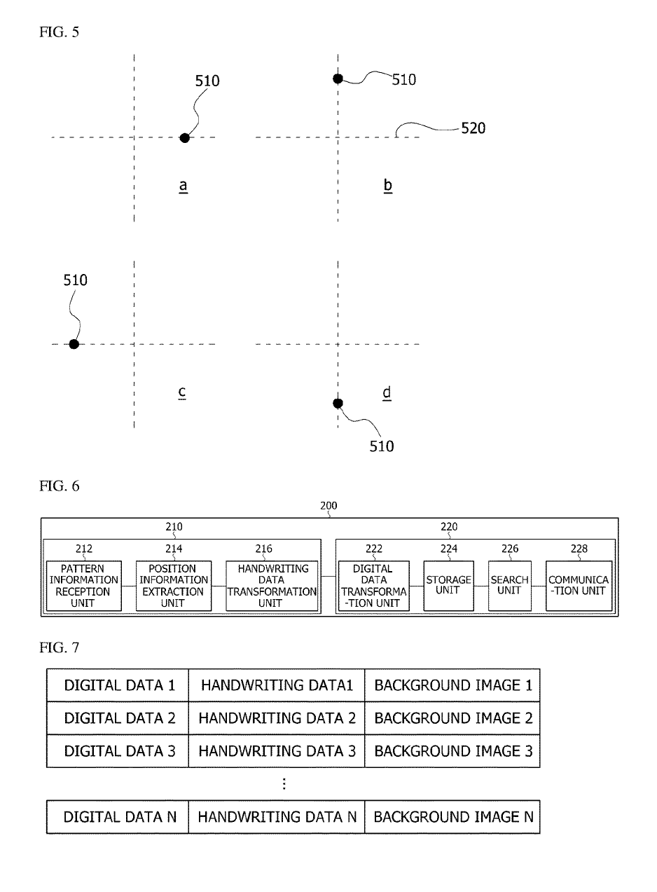

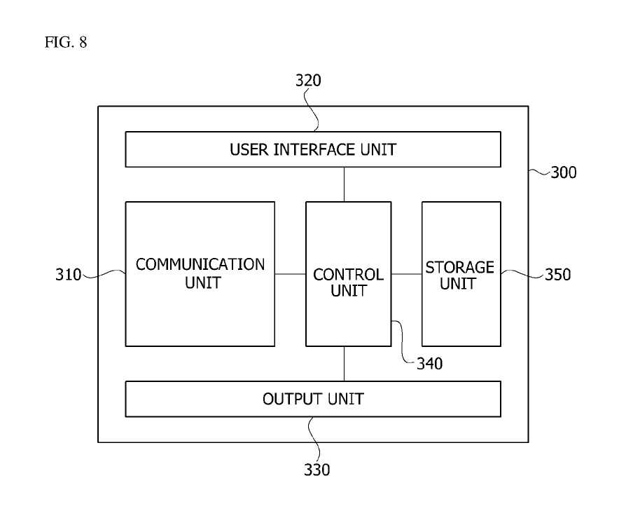

FIG. 1 is a block diagram illustrating a search system according to an embodiment of the present disclosure; FIG. 2 is an example of an electronic pen according to an embodiment of the present disclosure; FIG. 3 is an example of an electronic pen and a recording medium according to an embodiment of the present disclosure; FIGS. 4 and 5 are views for describing a dot pattern formed on a recording medium according to an embodiment of the present disclosure; FIG. 6 is a block diagram of an information processing system according to an embodiment of the present disclosure; FIG. 7 illustrates an example in which digital data, handwriting data, and a background image are stored in a storage unit of an information management device according to an embodiment of the present disclosure; and FIG. 8 is a block diagram of a user terminal according to an embodiment of the present disclosure.

Referring to FIG. 1, a search system 10 includes an electronic pen 100, an information processing system 200, and a user terminal 300.

The electronic pen 100 detects pattern information of a recording medium with a pattern formed thereon. Here, the pattern is used to determine positions on the recording medium and may be formed as various shapes such as a dot shape, a linear shape, a diagonal shape, a curved shape, and a ring shape. Although a dot-shaped dot pattern is described herein as an example for convenience of description, this is merely illustrative, and the present disclosure is not limited thereto. Positions on the recording medium may be identified using the pattern information detected by the electronic pen 100.

The information processing system 200 transforms the pattern information received from the electronic pen 100 into handwriting data. Here, the pattern information may refer to the pattern information itself detected by the electronic pen 100 or position information (e.g., absolute coordinates) extracted from the pattern information. For example, after detecting the pattern information on the recording medium, the electronic pen 100 may extract position information from the pattern information and transmit the position information to the information processing system 200. In another example, the electronic pen 100 may transmit the pattern information on the recording medium to the information processing system 200, and the position information may be extracted from the pattern information by the information processing system 200.

In addition, the information processing system 200 transforms handwriting data into digital data and stores the handwriting data and the digital data. Also, when a search request including a keyword is received from the user terminal 300, the information processing system 200 searches for digital data including the keyword and transmits handwriting data corresponding to the found digital data to the user terminal 300.

The user terminal 300 accesses the information processing system 200 to transmit a search request and outputs a result transmitted from the information processing system 200.

Referring to FIGS. 2 and 3, the electronic pen 100 includes a body unit 110 and a writing unit 120 provided at one end of the body unit 110 to detect pattern information of a recording medium with a dot pattern formed thereon.

The body unit 110 may be formed including one of a composite resin of an acrylonitrile butadiene styrene (ABS) copolymer and polycarbonate (PC), a synthetic resin such as polypropylene (PP) and polyphenylene sulfide (PPS), polymethyl methacrylate (PMMA) synthetic resin, polystyrene (PS) synthetic resin, glass, metals, and a mixture selected therefrom.

The body unit 110 may be formed to have a uniform diameter from top to bottom or to have a large diameter at the top and a small diameter at the bottom, and a cover (not shown) may be formed at both end portions of the body unit 110.

The writing unit 120 includes a pen tip unit 121 that is able to record on a recording medium 400, a pressure sensor 123 that generates information on a pen pressure applied to the pen tip unit 121, an infrared light source 125 that outputs infrared rays to the recording medium 400, an infrared sensor 127 that detects infrared rays scattering on the recording medium 400, and a detection unit 129 that uses the detected infrared rays to detect pattern information.

The pen tip unit 121 may be formed on the form of a pen tip protruding outward from one end of the body unit 110.

The pressure sensor 123 may be adjacent to the pen tip unit 121 and may detect a pressure applied to the pen tip unit 121. When contact between the pen tip unit 121 and the recording medium 400 occurs, the pressure sensor 123 may generate pen pressure information by calculating a pressure proportional to a force applied to the pen tip unit 121 as a numerical value.

The infrared light source 125 projects infrared rays when the pen tip unit 121 is in contact with the recording medium 400 or approaches within a predetermined distance or less of the recording medium 400.

The infrared sensor 127 is adjacent to the pen tip unit 121 and detects infrared rays scattering on the recording medium 400.

The detection unit 129 uses infrared rays detected by the infrared sensor 127 to detect a dot pattern on the recording medium 400.

Meanwhile, the recording medium 400 may include a paper printed with a pattern, e.g., a dot pattern. The recording medium 400 may be, for example a book, a diary, or the like printed with a dot pattern.

The dot pattern formed on the recording medium according to an embodiment of the present disclosure will be described in detail with reference to FIGS. 4 and 5.

Referring to FIG. 4, a dot pattern 500 may include a plurality of marks 510, and the marks 510 may be formed at predetermined intervals with respect to intersection points of virtual grid lines 520. The marks 510 may provide pattern information by pattern values determined according to positions at which the marks 510 are formed with respect to the intersection points of the virtual grid lines 520.

The marks 510 may be formed using infrared absorbing ink including, for example, one of a phthalocyanine-based compound, a naphthalocyanine-based compound, an a minimum-based compound, and a mixture selected therefrom. Accordingly, the infrared sensor 127 may detect infrared rays scattering at portions without the marks 510, and the detection unit 129 may calculate pattern information according to values of the marks 510 when thirty-six marks 510 with six marks 510 disposed at each row and column of the grid lines 520 at a size of 6 x 6 are recognized using the detected infrared rays.

The marks 510 are formed at predetermined intervals with respect to the intersection points of the virtual grid lines 520, and each of the marks 510 has a value. The value of each of the marks 510 may be formed of a combination of two or more different numbers.

The marks 510 may be formed in various shapes including a circular shape, an elliptical shape, a polygonal shape, a linear shape, etc.

Referring to FIG. 5, the marks 510 may be preset at four different positions according to relations with the intersection points of the virtual grid lines 520. A value of the mark 510 may be represented as “1” when the mark 510 is disposed at the right of the intersection point as shown in a, the value of the mark 510 may be represented as “2” when the mark 510 is disposed above the intersection point as shown in b, the value of the mark 510 may be represented as “3” when the mark 510 is disposed at the left of the intersection point as shown in c, and the value of the mark 510 may be represented as “4” when the mark 510 is disposed below the intersection point as shown in d. In this way, the pattern information may be detected according to positions of the marks 510 with respect to the intersection points of the virtual grid lines 520.

In addition, the marks 510 may also be formed in a diagonal direction instead of being formed on the virtual grid lines 520, and position information may be provided by a plurality of marks 510 formed at intersection points of one virtual grid line 520. In this case, each of the values of the marks 510 may be expressed with random coordinates including an x-coordinate and a y-coordinate, and the pattern information may be provided from the values of the marks 510 expressed with the coordinates.

The virtual grid lines 520 may be horizontally and vertically formed at predetermined intervals. A distance between the grid lines 520 may be 250 μm to 300 μm, and the marks 510 may be formed at points spaced apart by ⅛ to ¼ with respect to the intersection points of the virtual grid lines 520. Alternatively, two or more marks 510 may also be related and formed with respect to the intersection points of the virtual grid lines 520.

According to an embodiment of the present disclosure, the pattern information recognized by the electronic pen 100 may be transmitted to the information processing system 200, and the information processing system 200 may use the pattern information recognized by the electronic pen 100 to extract handwriting data.

Referring to FIG. 6, the information processing system 200 includes an information extraction device 210 and an information management device 220. Here, although the information extraction device 210 and the information management device 220 are shown as belonging to one system, embodiments are not limited thereto. The information extraction device 210 and the information management device 220 may also be implemented as independent devices which may communicate with each other. For example, the information extraction device 210 may be an information processing device, e.g., a personal computer (PC), a laptop computer, a tablet PC, a smartphone, or the like, and the information management device 220 may be a search server.

Here, the information extraction device 210 may include a pattern information reception unit 212, a position information extraction unit 214, and a handwriting data conversion unit 216.

The pattern information reception unit 212 may receive pattern information from the electronic pen 100. For example, the pattern information reception unit 212 may communicate with the electronic pen 100 by wire or wirelessly and may receive pattern information detected by the electronic pen 100 according to positions of the marks 510 with respect to the intersection points of the virtual grid lines 520.

In addition, the position information extraction unit 214 extracts position information (e.g., absolute coordinates) from the received pattern information. Here, the position information may include, for example, information on a position at which the electronic pen 100 begins to be in contact with the recording medium 400, information on positions at which the electronic pen 100 moves while continuously being in contact with the recording medium 400, information on a position at which the electronic pen 100 has lastly been in contact with the recording medium 400, etc. When the electronic pen 100 extracts position information from the pattern information and transmits the position information to the information extraction device 210, the position information extraction unit 214 may be omitted.

In addition, the handwriting data conversion unit 216 transforms the extracted position information into handwriting data. Here, the handwriting data may include handwriting recorded on the recording medium 400 by the electronic pen 100.

Meanwhile, the information management device 220 may include a digital data conversion unit 222, a storage unit 224, a search unit 226, and a communication unit 228.

The digital data conversion unit 222 transforms the handwriting data received from the information extraction device 210 into digital data. Here, the digital data may include digital fonts transformed from handwriting. Here, the digital font may include a keyword transformed from the handwriting. For example, when the handwriting data is “Hello, I'm singer OOO. The new year, 2014, has come. Happy new year!” written with a celebrity's handwriting, the digital data conversion unit 222 may extract “Hello, I'm singer OOO. The new year, 2014, has come. Happy new year!” from the handwriting data and transform all of the handwriting data into the digital font or extract only keywords such as “singer OOO,” “2014,” and “new year” and transform only the keywords into the digital font.

The storage unit 224 stores digital data and handwriting data. Here, the storage unit 224 may match and store the digital data and corresponding handwriting data. In addition, the storage unit 224 may further store a background image together with the handwriting data. Here, the background image may be printed in advance on the recording medium 400 which is being written on with the electronic pen 100. For this, the information management device 220 may store a background image according to pattern information. In addition, the pattern information received from the electronic pen 100 may be used to extract a pre-stored background image. The background image may be a drawing drawn by a creator using the electronic pen 100. The background image may also be a virtual background preset by the creator of handwriting. FIG. 7 illustrates an example in which digital data, handwriting data, and a background image are stored in the storage unit 224 of the information management device 220 according to an embodiment of the present disclosure. As illustrated in FIG. 7, the digital data, the handwriting data, and the background image may be stored by grouping the digital data with handwriting data, and background data corresponding thereto. The handwriting data may be combined with the background image, and the handwriting data and the background image may also be stored as a single image file.

Meanwhile, the search unit 226 searches for digital data including a keyword requested to be searched for by the user terminal 300 and extracts handwriting data corresponding to the digital data. For example, when the user terminal 300 has input “singer OOO” as a keyword and requested that the keyword be searched for, the search unit 226 may search for digital data including “singer OOO” and extract handwriting data corresponding to the digital data.

The communication unit 228 may communicate with the user terminal 300, receive a keyword from the user terminal 300, and transmit handwriting data to the user terminal 300.

When handwriting data and a background image are stored in a pair as illustrated in FIG. 7, at least one of the storage unit 224, the search unit 226, and a processing unit (not illustrated) may combine the handwriting data with the background image to form an image file, and the image file may be transmitted to the user terminal 300 via the communication unit 228. Alternatively, each of the handwriting data and the background image may be transmitted to the user terminal 300 via the communication unit 228, and the user terminal 300 may combine the handwriting data with the background image to form the image file and output the image file on a screen.

When the handwriting data is stored in the form of an image file in the storage unit 224 by being combined with a background image, the communication unit 228 may also transmit an image to the user terminal 300.

Although the information processing device 210 is illustrated as including the pattern information reception unit 212, the position information extraction unit 214, and the handwriting data conversion unit 216 and the information management device 220 is illustrated as including the digital data conversion unit 222, the storage unit 224, the search unit 226, and the communication unit 228 in FIG. 6, one or more functions of the information processing device 210 may be included in the information management device 220, and one or more functions of the information management device 220 may also be included in the information processing device 210.

Meanwhile, referring to FIG. 8, the user terminal 300 may be a PC, a laptop computer, a smartphone, a tablet PC, etc.

The user terminal 300 includes a communication unit 310, a user interface unit 320, an output unit 330, a control unit 340, and a storage unit 350. However, not all of the illustrated elements are essential. The user terminal may also be implemented with more or less elements than the number of elements illustrated in FIG. 8.

The communication unit 310 may include a mobile communication module and a wireless Internet module, and the modules may be entirely or partially integrated into a single module.

The mobile communication module transmits and receives wireless signals to and from one or more of a base station, an external terminal, and a server in a mobile communication network. The wireless signals may include various forms of data according to voice call signals, video call signals, or transmission and reception of text messages or multimedia messages.

The wireless Internet module refers to a module for wireless Internet access and may be embedded or externally provided. A wireless local area network (WLAN), wireless fidelity (Wi-Fi), wireless broadband (Wibro), Worldwide Interoperability for Micro-wave Access (WiMAX), High Speed Downlink Packet Access (HSDPA), etc. may be used as a wireless Internet technology.

The user interface unit 320 receives data or information for controlling an operation of a terminal from a user. The user interface unit 320 may be a key pad, a dome switch, a touch pad (hydrostatic or electrostatic), a jog wheel, a jog switch, a microphone, etc.

The output unit 330 displays information processed in the user terminal 300 in various forms of signals (e.g., sound signals and visual signals). The output unit 330 may be, for example, a liquid crystal display (LCD), a light emission diode (LED) display, an organic LED (OLED) display, a speaker, etc.

The control unit 340 controls an overall operation of the user terminal 300. For example, the control unit 340 performs overall controlling and processing associated with voice calls, data communication, video calls, etc.

The storage unit 350 stores a program for operating the control unit 340 and temporarily stores data being input thereto and output therefrom. The user terminal 300 may also operate in association with a web storage that performs a storing function of the storage unit 350 on the Internet.

According to an embodiment of the present disclosure, when the user interface unit 320 of the user terminal 300 receives digital data related to a predetermined keyword from the user, the communication unit 310 requests that the information processing system 200 search for the corresponding keyword. When the communication unit 310 receives handwriting data related to the predetermined keyword from the information processing system 200, the output unit 330 displays an image file including the handwriting data.

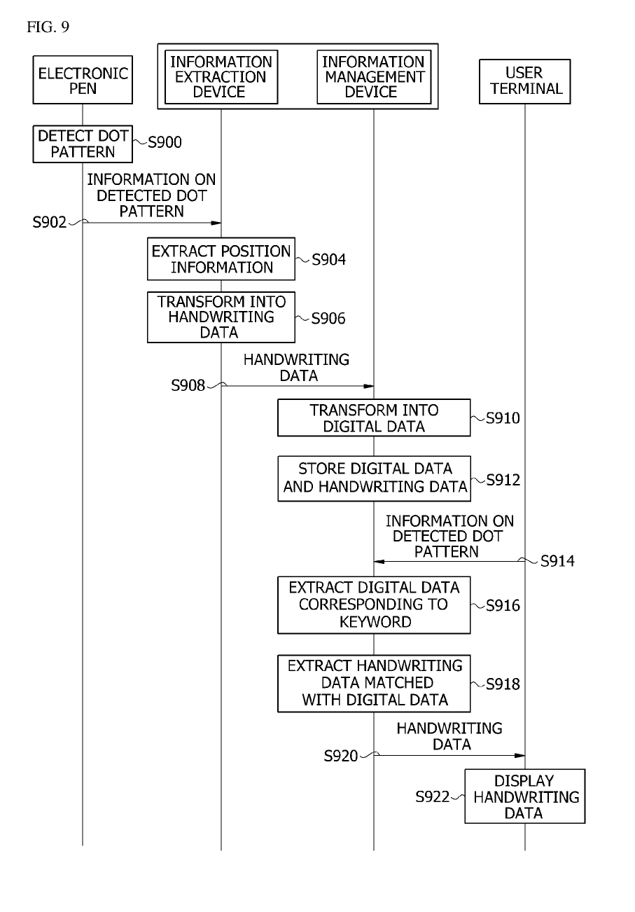

FIG. 9 is a flowchart illustrating a handwriting search method of a search system according to an embodiment of the present disclosure. Descriptions overlapping those with reference to FIGS. 1 to 8 will be omitted.

Referring to FIG. 9, the electronic pen 100 detects a dot pattern on the recording medium 400 (S900) and transmits pattern information related to the detected dot pattern to the information extraction device 210 (S902).

The information extraction device 210 uses the pattern information received from the electronic pen 100 to extract position information (S904) and transforms the extracted position information into handwriting data (S906). When the electronic pen 100 extracts position information from the pattern information and transmits the position information to the information extraction device 210, Step S904 may be omitted.

The information extraction device 210 transmits the transformed handwriting data to the information management device 220 (S908), and the information management device 220 transforms the handwriting data into digital data (S910) and then stores the digital data and the handwriting data (S912).

Meanwhile, when the user terminal 300 has accessed the information processing system 200 and requested that the information processing system 200 search for a predetermined keyword (S914), the information management device 220 extracts digital data corresponding to the predetermined keyword (S916) and extracts handwriting data matching the extracted digital data (S918). In addition, the information management device 220 transmits the extracted handwriting data to the user terminal 300 (S920), and the user terminal 300 displays the handwriting data received from the information management device 220 (S922).

In this way, since handwriting recorded by the electronic pen 100 is transformed into handwriting data and digital data in advance and the handwriting data and the digital data are stored together, the handwriting may be searched for within a short time when a search request is made by the user terminal 300.

The term “-unit” used herein refers to a software element or a hardware element such as a field-programmable gate array (FPGA) and an application-specific integrated circuit (ASIC), and a “-unit” play certain roles. However, a “-unit” is not limited to software or hardware elements. A “-unit” may be configured to be in an addressable recording medium or may also be configured to be reproduced by one or more processors. Consequently, for example, a “-unit” may include an element such as a software element, an object-oriented software element, a class element, and a task element, a process, a function, a feature, a procedure, a sub-routine, a segment of a program code, a driver, firmware, a microcode, a circuit, data, a database, a data structure, a table, an array, and a variable. Functions provided in elements and “units” may be combined into a smaller number of elements and “-units” or may be further separated into a larger number of elements and “-units”. In addition, the elements and the “-units” may also be implemented to reproduce one or more central processing units (CPUs) within a device or a security multimedia card.

Although descriptions have been given above with reference to an exemplary embodiment of the present disclosure, those of ordinary skill in the art should understand that various modifications and changes may be made to the present disclosure within the scope not departing from the spirit and area of the present disclosure written in the claims below.

1. An information processing system for a handwriting search, the information processing system comprising:
an information extraction device configured to transform pattern information detected by an electronic pen from a recording medium with a pattern formed thereon into handwriting data; and
an information management device configured to transform the handwriting data into digital data, store the handwriting data and the digital data, search for digital data including a keyword when a search request including the keyword is received from a user terminal, and transmit handwriting data corresponding to the found digital data to the user terminal.

2. The information processing system of claim 1, wherein the handwriting data includes handwriting recorded on the recording medium by the electronic pen, and the digital data includes a digital font transformed from the handwriting.

3. The information processing system of claim 2, wherein the digital font includes a keyword transformed from the handwriting.

4. The information processing system of claim 2, wherein the information management device includes:
a digital data conversion unit configured to transform handwriting data received from the information extraction device into digital data;
a storage unit configured to store the handwriting data and the digital data;
a search unit configured to search for digital data including the keyword and extract handwriting data corresponding to the digital data; and
a communication unit configured to communicate with the user terminal, receive the keyword from the user terminal, and transmit the handwriting data to the user terminal.

5. The information processing system of claim 4, wherein the storage unit further stores a background image together with the handwriting data.

6. The information processing system of claim 5, wherein:
the search unit combines the handwriting data with the background image; and
the communication unit transmits an image file in which the handwriting data is combined with the background image to the user terminal.

7. An information processing method for a handwriting search in an information processing system, the information processing method comprising:
transforming pattern information detected by an electronic pen from a recording medium with a pattern formed thereon into handwriting data;
transforming the handwriting data into digital data;
storing the handwriting data and the digital data;
searching for digital data including a keyword when a search request including the keyword is received from a user terminal; and
transmitting handwriting data corresponding to the found digital data to the user terminal.

8. The information processing method of claim 7, wherein the handwriting data includes handwriting recorded on the recording medium by the electronic pen, and the digital data includes a digital font transformed from the handwriting.

9. The information processing method of claim 8, wherein the digital font includes a keyword transformed from the handwriting.
